(19) United States
(12) Patent Application Publication
(10) Pub. No.: US 2025/0269306 A1
(43) Pub. Date: Aug. 28, 2025

(54) BERNOULLI FILTER DEVICE AND METHOD OF CLEANING A BERNOULLI FILTER DEVICE

(71) Applicant: Georg Schünemann GmbH, Bremen (DE)

(72) Inventor: Wolfgang Linster, Bremen (DE)

(21) Appl. No.: 19/064,137

(22) Filed: Feb. 26, 2025

(30) Foreign Application Priority Data
Feb. 26, 2024 (DE) 102024105325.9

(51) Int. Cl. B01D 29/66

(52) U.S. Cl. CPC B01D 29/665; B01D 29/668

(57) ABSTRACT

The invention relates to a filtering apparatus for filtering a fluid, in particular a Bernoulli filtering apparatus, comprising a housing, an inlet port for admitting the fluid to be filtered into the housing, at least one filter element, disposed in the housing, for filtering the fluid, an outlet port for discharging the filtered fluid from the housing, and a filter cleaning mechanism for cleaning the filter element of residues from the filtered fluid, wherein a pressure maintenance unit for maintaining a defined minimum pressure in the housing during cleaning is associated with the outlet port for the filtered fluid on the housing.

### CROSS REFERENCE TO RELATED APPLICATION

This application claims priority to German Patent Application No. 102024105325.9, filed Feb. 26, 2024, the disclosure of which is incorporated by reference herein in its entirety.

### TECHNICAL FIELD

The invention relates to a filtering apparatus for filtering a fluid, in particular a Bernoulli filtering apparatus, comprising a housing, an inlet port for admitting the fluid to be filtered the fluid to be filtered into the housing, at least one filter element, arranged in the housing, for filtering the fluid, an outlet port for discharging the filtered fluid from the housing, and a filter cleaning mechanism for cleaning the filter element of residues from the filtered fluid. The invention also relates to a method for cleaning a filtering apparatus.

### BACKGROUND

Filtering apparatuses of the kind initially specified are known from the prior art and are used to filter impurities from a wide variety of conveyed process fluids in a wide variety of industrial applications, for example in the petrochemical or pharmaceutical industry, or also in shipbuilding or agriculture. Such a filtering apparatus generally has a housing with an inlet port and an outlet port and a filter element disposed in the housing. The fluid to be filtered is admitted into the housing via the inlet port, freed of the impurities it contains by the filter element disposed in the housing, which in many cases is cylindrical in shape, before the filtered fluid is discharged from the housing via the outlet port.

Such generic filter apparatuses also have a filter cleaning mechanism for cleaning the filter element of the residues from the filtered fluid that have accumulated in the filter element. The filter cleaning mechanism preferably has at least one filter cleaning element which is inserted into the filter element and moved along a central axis of the filter element during cleaning, in particular along the inner side of the filter element. A flushing flow is also fed through the housing and along a section of the filter element. Due to the cross-sectional narrowing that exists between the cleaning element and the inner side of the filter element, there is a higher flow velocity on the inner side of the filter element. Due to the higher flow velocity, the residues deposited in the filter element are flushed off with the flushing flow and discharged. Such a filter element is generally cleaned contactlessly solely by the increase in flow velocity that is produced.

DE 10 2005 055 555 A1, DE 10 2011 007 003 A1 or DE 10 2018 123 151 A1, for example, disclose filter apparatuses for cleaning fluids or for killing living organisms contained in a fluid. In addition to maximizing the throughput to be achieved with such a filtering apparatus when filtering the fluids, there is an increasing need to increase the grade of filtration so as to be able to filter out even smaller impurities from a fluid to be filtered, using such filtering apparatuses. This necessitates removing the filtered residues from a filter element used in the apparatus, after a certain number of operating hours, in order to restore its full operability and to extend its service life and to be able to use it for an almost unlimited number of filtering operations. With regard to the grade of filtration, which is often defined in terms of the pore size of the filter materials used in designing the filter element, it has been shown in the prior art that the filter elements are insufficiently cleaned when pore sizes of less than 100 μm are used in such filtering apparatus, in particular in Bernoulli filtering apparatuses. For that reason, only filter elements having a limited pore size greater than 100 μm may be used in prior art filtering apparatuses that have to guarantee a certain minimum service life of the filter elements.

### SUMMARY OF THE INVENTION

The object of the invention is therefore to provide a filtering apparatus and a method for cleaning such an apparatus, with the aid of which even filter elements with a higher grade of filtration can be used and cleaned in a simple manner. In particular, the object of the invention is to specify a filtering apparatus and a cleaning method which disclose at least one alternative embodiment to the apparatuses and methods known from the prior art.

The invention achieves its object with a filtering apparatus for filtering a fluid, in particular a Bernoulli filtering apparatus, having the features of claim 1. In particular, a pressure maintenance unit for maintaining a defined minimum pressure in the housing during cleaning is associated with the outlet for the filtered fluid on the housing.

The approach pursued by the invention is to ensure, with the aid of the pressure maintenance unit associated with the outlet in the housing of the apparatus, that a defined internal pressure, by which the effectiveness of the cleaning operation is enhanced, prevails in the housing of the apparatus while the filter element is being cleaned. The pressure maintenance unit associated with the housing outlet has the effect, In particular, that due to the pressure prevailing on the outer side of the filter element while the filter element is being cleaned and during associated channeling of the flushing flow along a section of the filter element, in particular along its inner side, a greater pressure difference is produced between the inner side and the outer side of the filter element, resulting in a kind of backflushing effect in that section of the filter element. This thus improves the removal and flushing away of any residues that have accumulated on the inner side of the filter element. Due to the improved efficacy of filter element cleaning, it is also possible now for filter elements with a higher grade of filtration to be used, and the required service life to be achieved, which otherwise could not be used in the filter apparatuses known from the prior art.

According to a preferred development of the invention, the filter cleaning mechanism is adapted to efficaciously clean filter elements having a pore size of less than 100 μm, preferably of less than 70 μm, and particularly preferably of less than 40 μm. The pressure maintenance unit produces a high, preferably constant pressure on the outer side of the filter element in the housing of the filtering apparatus, which supports the cleaning effect on the filter elements during cleaning. In particular, when the filter cleaning element is being moved along the inner side of the filter element, and the higher flow velocity is produced between the filter cleaning element and the inner side of the filter element, the flushing operation carried out during cleaning of the filter element generates the pressure difference relative to the outer side of the filter element, which then has a positive impact. Due to the resulting pressure difference, flushing of the filter element causes the fluid to be backflushed from the outer side to the inner side of the filter element at the level of the filter cleaning element, in addition to the higher flow velocity during flushing of the filter element. This facilitates the removal of residues that have accumulated in the filter element and results in an overall improvement in the cleaning efficacy at the filter element. This means that filters with a pore size of preferably less than 100 μm, or preferably less than 70 μm, and particularly preferably of less than 40 μm can now be used in the filtering apparatus according to the invention, in particular in a Bernoulli filtering apparatus.

In a preferred embodiment of the filtering apparatus, the pressure maintenance unit is integrated directly into the outlet port on the housing. This results in a compact design of the filtering apparatus according to the invention. Moreover, the minimum pressure in the housing, which supports the cleaning of the filter element and which is preferably at least 0.7 bar, is confined to that part, of a system comprising the filtering apparatus, in which the pressure is primarily needed. Integrating the pressure maintenance unit into or onto the housing of the filtering apparatus obviates the need for further components or elements and thus results in low-cost production overall compared to the pressure maintenance unit being designed as a separate component. To connect the inventive filtering apparatus to the rest of the system, all that needs to be done is to couple the respective connecting lines to the input and output ports on the housing.

The pressure maintenance unit preferably has a channel section for the filtered fluid, which has a reduced cross-section in relation to the outlet port on the housing. By the pressure maintenance unit preferably mounted directly in the outlet port on the housing, the flow cross-section is reduced compared to a housing outlet port that has no pressure maintenance unit disposed therein. The filtering apparatus according to the invention can now be used in areas that, due to their low volumetric flow rate, would otherwise be unsuitable for such filter apparatuses. Special applications involving relatively low volumetric flow rates, in which or by which it would not otherwise be possible to clean a filter element efficaciously, can now be deployed to clean the filter element, despite their relatively low volumetric flow rates, due to the maintenance of pressure in the region of the outlet port of the housing.

In a particularly preferred embodiment, the pressure maintenance unit is provided in the form of a nozzle or adjustable aperture, the reduced flow cross-sections of which can be used to maintain the required pressure in the filtering apparatus, in particular in a Bernoulli filtering apparatus, at least for the filter element cleaning to be carried out at certain intervals.

According to a preferred development of the filtering apparatus according to the invention, the pressure maintenance unit is provided in the form of a pressure maintenance valve. Providing the pressure maintenance unit in the form of a pressure maintenance valve is a constructionally simple way to maintain a required pressure inside the housing of the filtering apparatus. By a pressure maintenance valve, a minimum pressure to be achieved can preferably be obtained inside the housing and thus at both the input port and the output port of the filtering apparatus according to the invention, without allowing the flow of fluid to flow through the pressure maintenance unit, in particular during flushing of the filter element. The minimum pressure to be generated inside the housing is preferably about 0.7 bar, at or above which a reliable cleaning effect can be achieved, even at relatively low volumetric flow rates, due to the ensuing backflushing effect at the filter element.

According to a development of the filtering apparatus according to the invention, the pressure maintenance unit has a flange member which defines its outlet cross-section and which is preferably arranged on a connector flange at the housing outlet. The flange member of the pressure maintenance unit shuts off a large part of the outlet port on the housing of the filtering apparatus, with the result that a possibly desired reduction in flow cross-section is realized in a simple manner. In combination, specifically, with a pressure maintenance unit provided in the form of a nozzle or aperture, the reduction in flow cross-section produces the required increase in pressure in the housing of the filtering apparatus, although generating a pressure in the housing is associated with the flow of the fluid. The flange member of the pressure maintenance unit can also be connected relatively easily to a connector flange that is preferably arranged at the outlet port of the housing, and in particular can be mounted thereon by a screw connection.

One or more outlet ports, which preferably extend in the shape of an arc on a circular path about a central axis (M) of the flange member, are preferably provided on the flange member. With the aid of such outlet ports on the flange member, the flow cross-section for the fluid to be filtered is reduced by 60% compared to the flow cross-section of the housing outlet port without the pressure maintenance unit disposed therein. A limit is thus imposed on the maximum volumetric flow rate that can be passed through by the filtering apparatus according to the invention. However, reducing the flow cross-section, in particular at the outlet port of the housing, allows a filtering apparatus designed in this way to now be used for applications involving lower volumetric flow rates. With the aid of the outlet ports preferably extending in the shape of an arc around the central axis of the flange member, the maximum potentially available area on the flange member is used to provide the outlet port for discharging the filtered fluid.

According to a development of the filtering apparatus according to the invention, the pressure maintenance valve has a movable valve body which is held in its closed position by a spring element acting on the valve body. The movable valve body cooperates, in particular, with an annular disk that includes a valve seat. The annular disk, the outer circumference of which is preferably in sealing contact with the wall of the cylindrically shaped outlet port of the housing, has a preferably circular recess arranged concentrically with the central axis of the annular disk. The recess on the annular disk is sealingly closed by the movable valve body when the latter is in its closed position. The spring element that cooperates with the valve body acts from the opposite end of the valve body from the annular disk and presses the valve body against the annular disk of the pressure maintenance valve with a presettable spring force. Not until the minimum pressure in the housing to be ensured by the pressure maintenance unit is exceeded is the valve body moved from its closed position to an open position by the fluid pressure prevailing in the housing, so that the fluid preferably flows from the inlet port towards the outlet port on the housing during the filtering operation.

In a preferred embodiment of the filtering apparatus, the pressure maintenance valve has a receiving sleeve for the valve body movable therein, which sleeve is arranged inside the housing outlet port and defines an annular space for the outflowing fluid that matches the outlet port on the flange member, wherein the receiving sleeve is preferably designed to project approximately perpendicularly from the flange member. By the preferably cylindrical receiving sleeve, the valve body is guided free of interference during its opening movement. The receiving sleeve arranged concentrically with the similarly cylindrical outlet port on the housing, and the wall of the outlet port surrounding the receiving sleeve also form an annular space in which the fluid flows substantially parallel with the central axis of the receiving sleeve. The free cross-section of the annular space between the outer side of the receiving sleeve and the wall of the housing outlet port is preferably approximately the same as the free cross-section of the recess on the annular disk of the pressure maintenance unit.

In one preferred embodiment, the receiving sleeve is preferably formed integrally on the flange member and preferably projects approximately perpendicularly from the flange member. The receiving sleeve for the movable valve body is centrally arranged on the flange member. In particular, the central axes of the receiving sleeve and the flange member are arranged concentrically.

According to a preferred development of the filtering apparatus according to the invention, in particular a Bernoulli filtering apparatus, the receiving sleeve has one or more ducts on its circumference for the filtered fluid passing through the outlet port on the housing, which are opened when the valve body moves out of its closed position. When the filtered fluid flows out of the housing of the filtering apparatus, a uniform force is exerted on the valve body, thus achieving a high level of functional reliability on the part of the pressure maintenance unit provided in the form of a pressure maintenance valve on the filtering apparatus. The flow direction of the filtered fluid is also changed as it flows through the pressure maintenance valve. In relation to the central axis of the receiving sleeve on the pressure maintenance valve, the fluid enters the pressure maintenance valve approximately parallel with the central axis and is radially deflected to the central axis of the receiving sleeve by the valve body arranged directly behind the annular disk in the direction of flow. After flowing through the ducts on the receiving sleeve, in the process of which the filtered fluid is distributed approximately uniformly over the circumference of the receiving sleeve, the fluid enters the annular space defined between the outer side of the receiving sleeve and the wall of the outlet port on the housing. Inside the annular space, the fluid flows approximately parallel with the central axis of the receiving sleeve in the direction of the at least one outlet port arranged in the flange member at the end of the annular space.

According to a preferred development of the invention, the housing has a substantially cylindrical filter chamber that extends along a longitudinal axis of the housing and inside which the filter element is disposed. The filter element with its two opposite ends is preferably accommodated sealingly within the housing, thus preventing the fluid to be filtered from flowing past the filter element in an undesired manner during the filtering operation. At each of its ends, the filter element preferably has a cylindrical sealing portion that sealingly matches the receptacles formed in the filter chamber. The filter chamber extends over approximately two-thirds to approximately four-fifths of the total height of the housing on the filtering apparatus.

According to a development of the invention, in particular of a filtering apparatus designed as a Bernoulli filtering apparatus, the filter cleaning mechanism has a filter cleaning element that is movable along the filter element and is adapted to generate a higher flow velocity on an inner side of the filter element during the cleaning operation along a section of the filter element. By providing a filter cleaning element and allowing the filter cleaning element to move along a section, in particular along an inner side of the filter element, in addition to the greater pressure difference building up between the inner side and the outer side of the filter element, the flow velocity of the flushing flow is preferably also increased, which locally improves the backflushing effect in that section of the filter element.

In one possible preferred embodiment of the filtering apparatus, the inlet port is arranged at a first end of the housing, in particular at a lower end of a filter chamber that receives the filter element, and/or the outlet port is arranged on a circumferential section of the housing, wherein the outlet port is preferably oriented approximately radially to the longitudinal axis of the housing. Via the inlet port, in particular at the lower end of the housing or filter chamber, the fluid to be filtered flows into the inner free cross-section of the filter element, from which the fluid flows substantially radially through the filter element from the inner side to the outer side of the filter element. The fluid, now filtered, on the outer side of the filter element is then discharged via the outlet port on the housing, and in particular via the pressure maintenance unit installed in the outlet port of the housing, into a fluid line connected to the outlet port of the filtering apparatus. The outlet port of the housing is arranged, in particular, on a circumferential section of the housing. The housing outlet port, with its pressure maintenance unit, preferably extends approximately radially to the longitudinal axis of the housing, as a result of which the filtered fluid is discharged uniformly from the entire outer circumferential surface in the direction of the outlet port.

According to a preferred development of the invention, the filter cleaning mechanism is arranged opposite the first end at the second end of the housing, from which point the filter cleaning element, which is a flushing disk arranged at one end of a lifting rod, can be moved along the inner side of the filter element. With the aid of the filter cleaning mechanism arranged at the end opposite the inlet port, the filter cleaning element provided in the form of a flushing disk is inserted into the free interior space of the filter element and thus along the inner side of the filter element, which is loaded with residues as a result of filtering. The outer diameter of the filter cleaning element is slightly smaller than the inner diameter of the cylindrical filter element, with a uniform cleaning gap preferably being formed between the inner side of the filter element and the filter cleaning element. If the fluid flows axially through the filter element during cleaning, in particular when the filter is being flushed, the fluid must flow through between the inner side of the filter element and the flushing disk. The flow velocity is greatly increased locally, and the static pressure is reduced accordingly, with the result that residues deposited on the inner side of the filter element are removed, and the filter element is cleaned. In addition to increasing the flow velocity, the pressure in the housing and on the outer side of the filter element produces a kind of backflushing effect from the outer side in the direction of the inner side, thus further facilitating the removal of residues from the filter element.

The filter cleaning element is moved, in particular with the aid of a lifting rod, from the upper end of the housing into the free interior space of the filter element in the filter chamber. In a preferred embodiment, the filter cleaning element has an actuator coupled to its lifting rod, for controlled motion along the inner side of the filter element. The actuator used to move the filter cleaning element may be designed as a hydraulic, pneumatic, electrical, electromagnetic or as some other kind of actuator. The actuator precisely controls the filter cleaning element provided in the form of a flushing disk, such that reliable cleaning is performed on the filtering apparatus according to the invention, in particular on the Bernoulli filtering apparatus.

According to a preferred development of the invention, the filter cleaning mechanism has a flushing system comprising at least one flushing outlet on the housing, for producing a flushing flow from the inlet port through the housing to the flushing outlet. Instead of briefly reversing the direction of flow through the filter element, the fluid for flushing the filter element is also fed in via the inlet port. During the flushing operation, the fluid entering via the inlet port flows through the filter chamber in a purely axial direction and generates a flow primarily on the inner side only of the filter element. The fluid loaded during flushing with the residues retained in the filter element is channeled, together with the residues, towards the second, upper end of the housing and is discharged from the filtering apparatus according to the invention via a flushing outlet in fluid communication with the second end of the housing.

The flushing outlet is preferably in fluid communication with the second end of the housing and can be brought into fluid communication with the filter chamber by a operable shutoff device located upstream from the flushing outlet. Switching between the filtering function and the cleaning operation on the filtering apparatus according to the invention can be carried out by simply actuating the shutoff device arranged upstream from the flushing outlet. When the shutoff device is opened, the pressure maintenance unit closes, with the result that, instead of continuing through the filter element, the fluid to be filtered now flows towards the second end of the housing opposite the inlet port on the housing, and further towards the flushing outlet, with the minimum pressure required in the housing in order to clean the filter element being maintained by the shutoff device, by controlling the extent to which it is opened. In conjunction with the pressure maintenance unit according to the invention, the effect is that no pressure is released in the direction of the housing outlet port. The pressure maintenance unit preferably provided in the form of a pressure maintenance valve moves automatically with its valve body to the closed position, thus counteracting any reverse flow of the fluid and preventing any air from inadvertently entering the housing of the filtering apparatus. In the present case, the shutoff device disposed upstream from the flushing outlet is a non-return valve whose open position is infinitely adjustable.

According to a further aspect, the invention relates to a method for cleaning a filtering apparatus, in particular a Bernoulli filtering apparatus, preferably according to at least one of the preferred embodiments above.

The method according to the invention achieves the object initially specified with the steps of: admitting a fluid via an inlet port of a housing and producing a flushing flow within the housing for cleaning a filter element accommodated in the housing; producing a higher flow velocity of the flushing flow between a filter cleaning element, which is moved along the filter element during cleaning, and an inner side of the filter element; discharging the fluid used to clean the filter element via a flushing outlet on the housing, which can be shut off by a shutoff device during the filtering operation of the apparatus, and maintaining a defined minimum pressure inside the housing during the cleaning operation by a pressure maintenance unit which is arranged at an outlet port of the housing that is used in filter operation to discharge the filtered fluid, and preferably by a shutoff device arranged upstream from the flushing outlet. The method according to the invention is based on the realization that, by maintaining a defined minimum pressure inside the housing, in particular inside a filter chamber formed inside the housing, a predetermined pressure acts on the outer side of the filter element and produces a kind of local backflushing effect of the fluid from the outer side of the filter element towards the inner side of the filter element during the flushing operation and the associated movement of the filter cleaning element along the filter element, in addition to the greater flow velocity between the filter cleaning element and the inner side of the filter element. This means that it is now possible, in conjunction with a filtering apparatus, to use relatively fine filter elements that after filtering could not be cleaned reliably of residues deposited thereon, unless a minimum pressure is maintained inside the housing. The method according to the invention also allows filter elements having a pore size of less than 100 μm, preferably of less than 70 μm, and particularly preferably of less than 40 μm to preferably also be used in filtering apparatuses, in particular in Bernoulli filtering apparatuses, to filter fluids and to achieve the desired service life with the filter elements thus used.

The embodiments and developments described with regard to the filtering apparatus according to the invention are also preferred embodiments of the method according to the invention for cleaning a filtering apparatus, and vice versa, unless particular features contradict each other.

### BRIEF DESCRIPTION OF THE DRAWINGS

The invention shall now be described in greater detail with reference to a preferred embodiment of a filtering apparatus and with reference to the attached Figures, in which

FIG. 1 shows a perspective, partially cutaway view of a filtering apparatus according to the invention, with its pressure maintenance unit;

FIG. 2 shows a perspective, partially cutaway view of the filtering apparatus, with the pressure maintenance unit shown in cross-section;

FIG. 3 shows a cross-sectional view of the filtering apparatus according to the invention and a filter element accommodated therein; and

FIG. 4 shows an enlarged view of the pressure maintenance unit shown in FIG. 3.

### DETAILED DESCRIPTION OF THE INVENTION

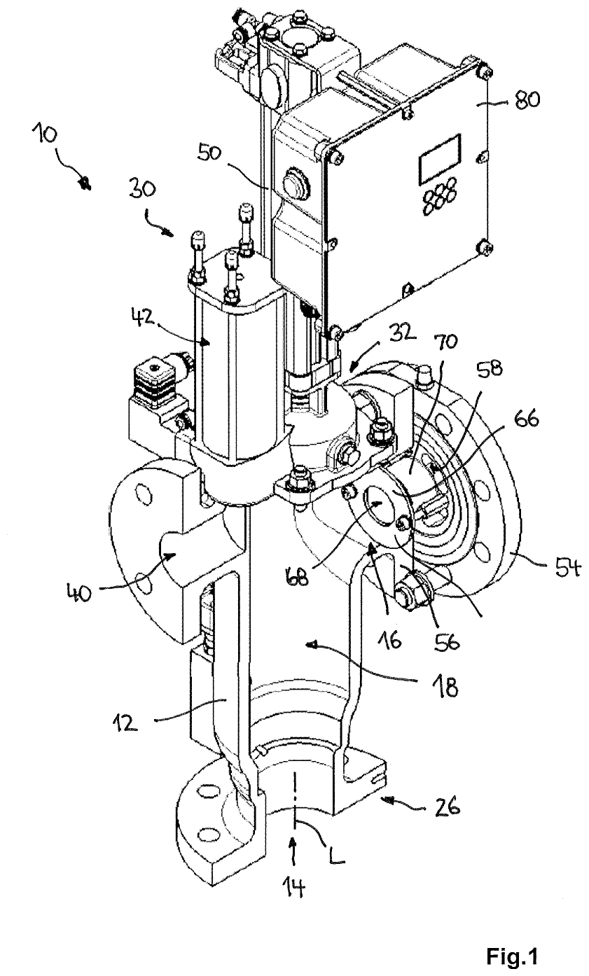

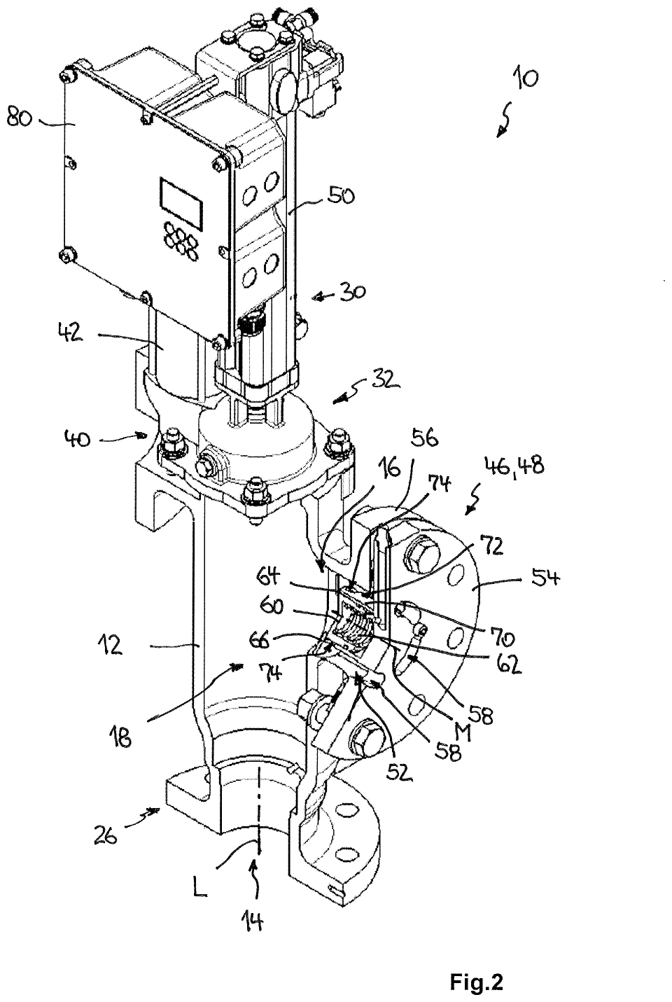

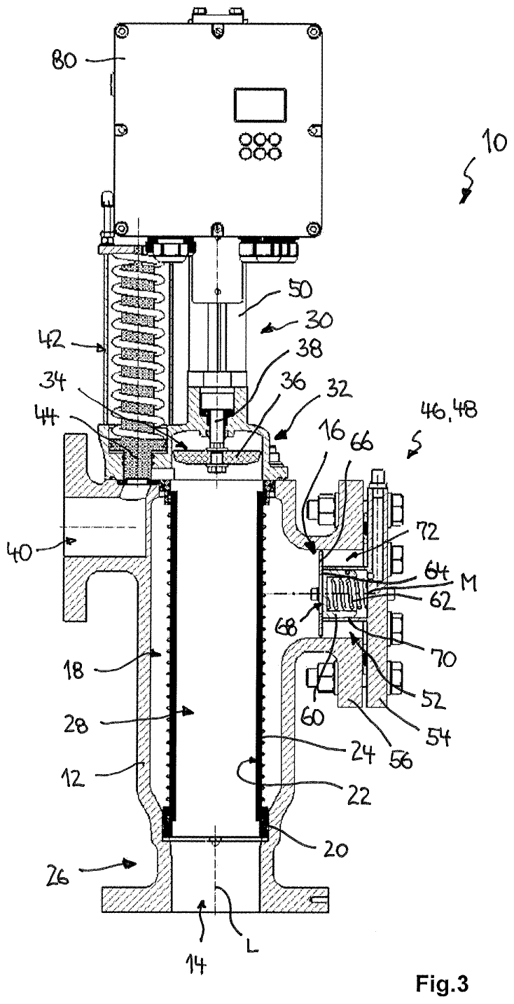

FIGS. 1 and 2 show a filtering apparatus 10 for filtering a fluid, in particular a Bernoulli filtering apparatus 10. Apparatus 10 comprises a housing 12 having an inlet port 14 for admitting the fluid to be filtered into housing 12, and an outlet port 16 for discharging the filtered fluid from housing 12. Housing 12 has a substantially cylindrical filter chamber 18 extending along a longitudinal housing axis L and with which a filter element 20 (FIG. 3) is associated. Filter element 20 is adapted to filter impurities from a fluid passing through filtering apparatus 10. During the filtering operation, the fluid to be filtered flows substantially from the inner side 22 towards the outer side 24 of filter element 20.

Inlet port 14 is arranged at a first end 26 of housing 12, in particular at a lower end of the filter chamber 18 in which filter element 20 is accommodated. Outlet port 16 is formed on a circumferential section of housing 12 and is oriented approximately radially to longitudinal housing axis L. During filter operation of filtering apparatus 10, the fluid to be filtered flows via inlet port 14 into the free interior space 28 in filter element 20 and is distributed approximately uniformly from there in a radial direction through filter element 20 via the outer periphery of filter element 20 towards outlet port 16 arranged on the circumference of housing 12, and further into a fluid line that is not shown in any further detail.

In order to clean filter element 20, which is carried out on filtering apparatus 10 at certain intervals, also depending on the extent to which filter element 20 is full of impurities, and thus discontinuously, filtering apparatus 10 has a filter cleaning mechanism 30 which is adapted to clean filter element 20 of residues from the filtered fluid deposited thereon.

As further shown in FIG. 3, filter cleaning mechanism 30 is arranged in particular at a second end 32 of housing 12 opposite the first end 26, and includes a filter cleaning element 34. Filter cleaning element 34 is moved from the second end 32 of housing 12 along filter element 20, preferably along the inner side 22 of filter element 20. Filter element 20 is flushed from the direction of inlet port 14 by a flushing system, not shown here, during the cleaning of filter element 20 in conjunction with the moving along of filter cleaning element 34, which in a preferred embodiment is provided in the form of flushing disk 36 and arranged at one end of a movably guided lifting rod 38. When flushing filter element 20, the fluid introduced via inlet port 14 is now channeled towards a flushing outlet 40 of the flushing system, instead of towards outlet port 16. The produced flushing flow through housing 12 flows from the inlet port at the first end 26 towards the upper end 32 of housing 12 and from there to flushing outlet 40, which is in fluid communication with the second end 32 of housing 12. During cleaning and flushing, a higher flow velocity is produced locally on the inner side 22 of the filter element, in alternating sections of filter element 20. To stop or start the flushing flow, a shutoff device 42 in the form of an electromagnetic non-return valve 44, which stays in its closed position when in the unactuated state, is arranged upstream from flushing outlet 40. There is no fluid communication between the second end 32 of housing 12 and flushing outlet 40 until shutoff device 42 has been actuated.

According to the present invention, a pressure maintenance unit 46 for maintaining a defined minimum pressure in housing 12 during the cleaning operation is associated with outlet port 16 on housing 12 for the filtered fluid, in order to ensure, in special applications where it is necessary to have filter elements with a relatively high grade of filtration, i.e. filter elements with a pore size of less than 200 μm, in particular less than 100 μm, preferably of less than 70 μm, and particularly preferably of less than 40 μm, that such filter elements 20 are cleaned efficaciously. By pressure maintenance unit 46, which is integrated directly into outlet port 16 on housing 12, the persistent pressure acting on the outer side 24 of filter element 20 during the flushing operation produces a kind of backflushing effect of the fluid from the outer side 24 towards the inner side of filter element 22 when filter cleaning element 34 is moved along the filter element, in addition to the higher flow velocity generated between filter cleaning element 34 and the inner side 22 of the filter element. This backflushing effect supports the removal of any residues that may have accumulated in filter element 20. By pressure maintenance unit 46 provided at outlet port 16 of housing 12, the cleaning effect in filtering apparatus 10, provided according to the invention in the form of Bernoulli filtering apparatus, is improved in such a way that even filter elements 20 with a pore size of less than 100 μm, preferably of less than 70 μm, and particularly preferably of less than 40 μm, can be cleaned reliably.

In the embodiment shown here in FIG. 3, pressure maintenance unit 46 is provided in the form of pressure maintenance valve 48, but may also be designed, in an embodiment not shown in further detail, as a nozzle or as an adjustable aperture. Filter cleaning element 34 is moved by an actuator 50, which is coupled to the lifting rod 38 of filter cleaning element 34. In one possible embodiment, pressure maintenance unit 46 has a channel section 52 for the fluid already filtered, which has a reduced free cross-section in relation to the outlet port 16 on housing 12 without pressure maintenance unit 46. Pressure maintenance unit 46 includes a flange member 54, by which the outlet cross-section of pressure maintenance unit 46 on filtering apparatus 10 is defined. Flange member 54 is arranged on a connector flange 56 at the outlet port 16 of housing 12. Flange member 54 shuts off the outlet port 16 of housing 12 almost completely.

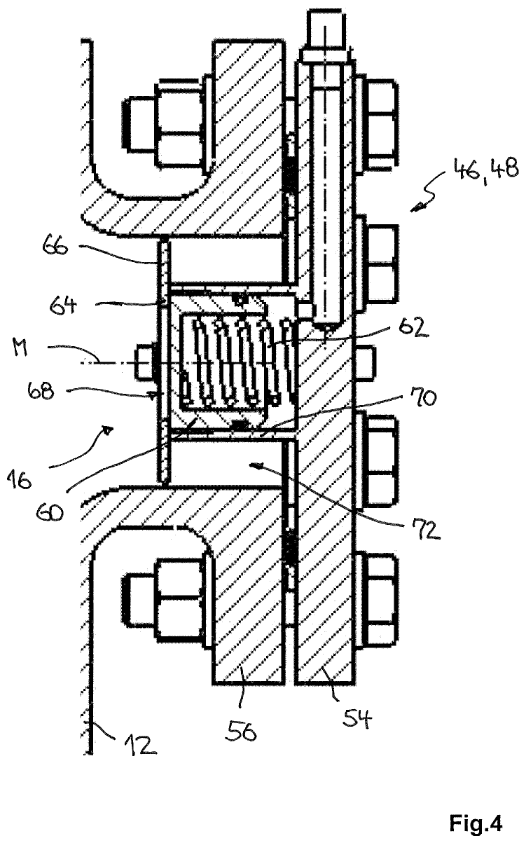

One or more outlet ports 58, which extend in the shape of an arc on a circular path about a central axis M of flange member 54, are provided on flange member 54. As can be seen from the enlarged view shown in FIG. 4, pressure maintenance unit 46 in the form of pressure maintenance valve 48 has a movable valve body 60, which is held in its closed position, against a valve seat 64 in annular disk 66, by a spring element 62 acting on valve body 60. Annular disk 66 has a central recess 68 forming the exit area from filter chamber 18 of housing 12 and the entry area for the filtered fluid at pressure maintenance unit 46.

Pressure maintenance valve 48 also includes a receiving sleeve 70 for the valve body 60 of pressure maintenance valve 48, which can be moved therein. In the embodiment shown here, receiving sleeve 70 is arranged on flange member 54, and in particular is integral with it. Receiving sleeve 70 projects approximately perpendicularly from one end face of flange member 54 about its central axis M. Receiving sleeve 70 is arranged inside the outlet port 16 on housing 12 and together with the outlet port 16 on housing 12 that surrounds receiving sleeve 70 on the outside, defines an annular space 72 for the outflowing filtered fluid. Annular space 72 is arranged to match the outlets 58 on flange member 54.

Receiving sleeve 70 also has one or more ducts 74 for the fluid on its circumference, which is or are opened when valve body 60 moves out of its closed position. When the filtered fluid flows through pressure maintenance unit 46, it is deflected at least twice inside pressure maintenance unit 46, wherein valve body 60 movably held inside receiving sleeve 70 is almost completely enclosed by the annular space 72 surrounding receiving sleeve 70.

A controller 80 is provided on filtering apparatus 10 for targeted controlling of actuator 50 of filter cleaning mechanism 30 and of shutoff device 42.

Filtering apparatus 10 is used to implement a method for cleaning such an apparatus, the method comprising the steps of: admitting a fluid via an inlet port 14 of a housing 12 and producing a flushing flow within housing 12 for cleaning a filter element 20 accommodated in housing 12; producing a higher flow velocity of the flushing flow between a filter cleaning element 34, which is moved along filter element 20 during cleaning, and an inner side 22 of filter element 20; discharging the fluid used to clean filter element 20 via a flushing outlet 40 on housing 12, which can be shut off by a shutoff device 42 during the filtering operation of apparatus 10, and maintaining a defined minimum pressure pmin inside housing 12 during the cleaning operation by a pressure maintenance unit 46, which is arranged at an outlet port 14 of housing 12 that is used in the filtering operation to discharge the filtered fluid, and by shutoff device 42 arranged upstream from flushing outlet 40.

### LIST OF REFERENCE SIGNS

10 Filtering apparatus
12 Housing
14 Inlet
16 Outlet
18 Filter chamber
20 Filter element
22 Inner side
24 Outer side
26 End
28 Interior space
30 Filter cleaning mechanism
32 End
34 Filter cleaning element
36 Flushing disk
38 Lifting rod
40 Flushing outlet
42 Shutoff device
44 Nonreturn valve
46 Pressure maintenance unit
48 Pressure maintenance valve
50 Actuator
52 Channel section
54 Flange member
56 Connector flange
58 Outlet
60 Valve body
62 Spring element
64 Valve seat
66 Annular disk
68 Recess
70 Receiving sleeve
72 Annular space
74 Duct
80 Controller
L Longitudinal axis of the housing
M Central axis
pₘᵢₙ Minimum pressure

What is claimed is:

1. A filtering apparatus for filtering a fluid, comprising:
a housing:
an inlet port for admitting the fluid to be filtered into the housing,
at least one filter element, disposed in the housing, for filtering the fluid,
an outlet port for discharging the filtered fluid from the housing, and
a filter cleaning mechanism for cleaning the filter element of residues from the filtered fluid,
wherein a pressure maintenance unit for maintaining a defined minimum pressure in the housing during cleaning is associated with the outlet port for the filtered fluid on the housing.

2. The filtering apparatus according to claim 1, wherein the filter cleaning mechanism is adapted to clean filter elements having a pore size of less than 100 μm.

3. The filtering apparatus according to claim 1, wherein the pressure maintenance unit is integrated directly into the outlet port on the housing.

4. The filtering apparatus according to claim 1, wherein the pressure maintenance unit has a channel section for the filtered fluid, which has a reduced cross-section in relation to the outlet port on the housing.

5. The filtering apparatus according to claim 1, wherein the pressure maintenance unit is provided in the form of a pressure maintenance valve.

6. The filtering apparatus according to claim 1, wherein the pressure maintenance unit has a flange member which defines its outlet cross-section and which is arranged on a connector flange at the housing outlet port.

7. The filtering apparatus according to claim 6, wherein a plurality of outlet ports are provided on the flange member, which extend in the shape of an arc on a circular path about a central axis of the flange member.

8. The filtering apparatus according to claim 5, wherein the pressure maintenance valve has a movable valve body which is held in its closed position by a spring element acting on the valve body.

9. The filtering apparatus according to claim 1, wherein the pressure maintenance valve has a receiving sleeve for the valve body movable therein, which sleeve is arranged inside the housing outlet port and defines an annular space for the outflowing fluid that matches the outlet on the flange member, wherein the receiving sleeve is adapted to project approximately perpendicularly from the flange member.

10. The filtering apparatus according to claim 9, wherein the receiving sleeve has one or more ducts for the fluid on its circumference, which are opened when the valve body moves out of its closed position.

11. The filtering apparatus according to claim 1,
wherein the housing has a substantially cylindrical filter chamber that extends along a longitudinal axis of the housing and inside which the filter element is disposed, and/or
the filter cleaning mechanism has a filter cleaning element that is movable along the along the filter element and is adapted to generate a higher flow velocity on an inner side of the filter element during the cleaning operation along a section of the filter element.

12. The filtering apparatus according to claim 1, wherein the inlet port is arranged at a first end of the housing, in particular at a lower end of a filter chamber that receives the filter element, and/or the outlet port is arranged on a circumferential section of the housing, wherein the outlet port is oriented approximately radially to the housing's longitudinal axis.

13. The filtering apparatus according to claim 11,
wherein the filter cleaning mechanism is arranged opposite the first end at the second end of the housing, from which point the filter cleaning element, which is a flushing disk arranged at one end of a lifting rod, can be moved along the inner side of the filter element, and
wherein the filter cleaning element has an actuator coupled to its lifting rod for controlled motion along the inner side of the filter element.

14. The filtering apparatus according to claim 1,
wherein the filter cleaning mechanism has a flushing system comprising at least one flushing outlet on the housing for producing a flushing flow from the inlet port through the housing to the flushing outlet, and
wherein the flushing outlet is in fluid communication with the second end of the housing and can be brought into fluid communication with the filter chamber by a operable shutoff device located upstream from the flushing outlet.

15. A method for cleaning a filtering apparatus according to claim 1, the method comprising:
admitting a fluid via an inlet port of a housing and producing a flushing flow within the housing for cleaning a filter element accommodated in the housing;
producing the flushing current along the filter element, in particular along an inner side of the filter element, producing a higher flow velocity of the flushing flow between a filter cleaning element, which is moved along the filter element during cleaning, and an inner side of the filter element;
discharging the fluid used to clean the filter element via a flushing outlet on the housing, which can be shut off by a shutoff device during the filtering operation of the apparatus; and
maintaining a defined minimum pressure inside the housing during the cleaning operation by a pressure maintenance unit which is arranged at an outlet port of the housing that is used in filter operation to discharge the filtered fluid, and by a shutoff device arranged upstream from the flushing outlet.
